(19) United States
(12) Patent Application Publication
(10) Pub. No.: US 2026/0147990 A1
(43) Pub. Date: May 28, 2026

(54) TERMINAL BRANDING WITH AUTOMATED MACHINE LEARNING MODEL (MLM) PROMPTS

(71) Applicant: NCR Voyix Corporation, Atlanta, GA (US)

(72) Inventors: Gina Torcivia Bennett, Lawrenceville, GA (US); Kip Oliver Morgan, Atlanta, GA (US); WuChieh James Jong, Raleigh, NC (US); Ajay Singh Gill, Buford, GA (US); Seoyeon Park, Lewisville, TX (US); Nikita Jha, Duluth, GA (US)

(21) Appl. No.: 18/962,981

(22) Filed: Nov. 27, 2024

(51) Int. Cl. G06F 40/186; G06F 40/103; G06F 40/14; G06F 40/40; G06T 11/00

(52) U.S. Cl. CPC G06F 40/186; G06F 40/103; G06F 40/14; G06T 11/10; G06F 40/40; G06T 2200/24

(57) ABSTRACT

Methods and a system for simplified computer terminal interface branding using machine-learning models (MLMs). The system includes a front-end interface that enables rapid personalization by generating logos, background images, and color specifications. The system processes brand information using large language MLMs to extract key concepts, which are then used to generate optimized image prompts. These prompts are provided to a MLM image generator to create themed background images for transaction workflows. The system automatically computes optimal text colors based on perceived brightness calculations and generates animation color schemes through red-green-blue (RGB) and hue-saturation-lightness (HSL) color space conversions. The methods and system enable rapid transaction interface personalization while maintaining high quality, reducing costs, and requiring minimal technical expertise from users.

### BACKGROUND

Designing and creating branding for user interfaces is an expensive and time-consuming process that requires significant technical expertise. Current branding processes often fail to meet customer timelines due to the complexity of prompt engineering, extensive color science knowledge requirements, and specialized artistic skills needed to create appropriate backgrounds. Design departments are frequently undervalued and cut to reduce costs, while brand descriptions and assets remain scattered across the internet in different formats. Additionally, many legacy products lack branding customization capabilities, making it difficult to maintain consistent brand identity across different platforms.

### BRIEF DESCRIPTION OF THE DRAWINGS

FIG. 1A is a diagram of a system for providing terminal branding with automated machine learning model (MLM) prompts, according to an example embodiment.

FIG. 1B is example pseudocode for a color processing algorithm, according to an example embodiment.

FIG. 2 is a flow diagram of a method for terminal branding with automated MLM prompts, according to an example embodiment.

FIG. 3 is a flow diagram of another method for terminal branding with automated MLM prompts, according to an example embodiment.

### DETAILED DESCRIPTION

Producing good results from machine learning models (MLMs) is extremely difficult and complex. Current branding processes and deployment timelines frequently fail to meet customer expectations due to several critical challenges. Designing and creating branding is an expensive and time-consuming process that requires significant technical expertise.

The process of implementing these designs onto actual machines is tedious and agonizing, while design departments are often undervalued and frequently the first to be cut when attempting to lower costs. Picking correct colors for buttons, text, and animations requires extensive knowledge of color science, while making artistic backgrounds demands significant training, practice, and skill. Additionally, brand descriptions, colors, and logos are scattered across the internet in disparate forms, making it difficult to maintain consistent brand identity. Many legacy products have become outdated due to their lack of branding customization capabilities, while accessibility laws impose specific technical requirements for contrast, sizing, and other human factors.

In an embodiment presented herein, a simplified MLM prompt interface for computer terminal branding consists of a rapid personalization feature that produces at least a logo, background images, and a color file (e.g., JSON color file, etc.). A technique presented herein employs a software process that uses MLMs usage and MLM prompt engineering while providing a simple interface for users. The process creates a common format for these entities that can be consumed by any endpoint.

Various processing features presented herein include automatically computing optimal text colors based on button background colors using perceived brightness calculations and generating approximately ten shades of animation colors by converting between red-green-blue (RGB) and hue-saturation-lightness (HSL) color spaces. In an embodiment, four themed background images are created that tell a transaction story (e.g., welcome background image, scan items background image, search background image, and thank you background image) corresponding to common transaction workflow states.

In an embodiment, a method utilizes a large language MLM to extract a core brand word or words based on brand descriptions obtained from web sites associated with the brand. The core brand word is then inserted into a simplified MLM prompt (e.g., natural language sentence) and provided to an MLM image generator for generating background objects with color schemes for selection as branded backgrounds to themes for transaction interface screens of a self-checkout (SCO) terminal. The technique presented herein enables rapid personalized branding while maintaining high quality branding, reducing costs associated with branding, and requiring minimal technical expertise from users for the personalized branding.

As used herein a “brand” is recognizable text, graphics, logos, animations, and/or images for a generic sport, a specific sport team, a famous individual, a popular company, a popular product of a company, a popular service of a company, a movie, and/or a popular event or holiday. A “theme” for an interface screen or window dictates an overall aesthetic design of the window, including colors, fronts, and graphical elements like borders, buttons, and shadows. A theme for a window is typically consistent across all the windows in an application. A “style” for a window defines specific attributes of functionality of an individual window, such as whether the window has a border, is resizable, has a title bar, and/or supports transparency. A “button” within a window refers to an interactive graphical element that users can click or select to perform a specific action or command. A “domain” is a base web or internet address most associated with a brand; for example, www.walmart.com®.

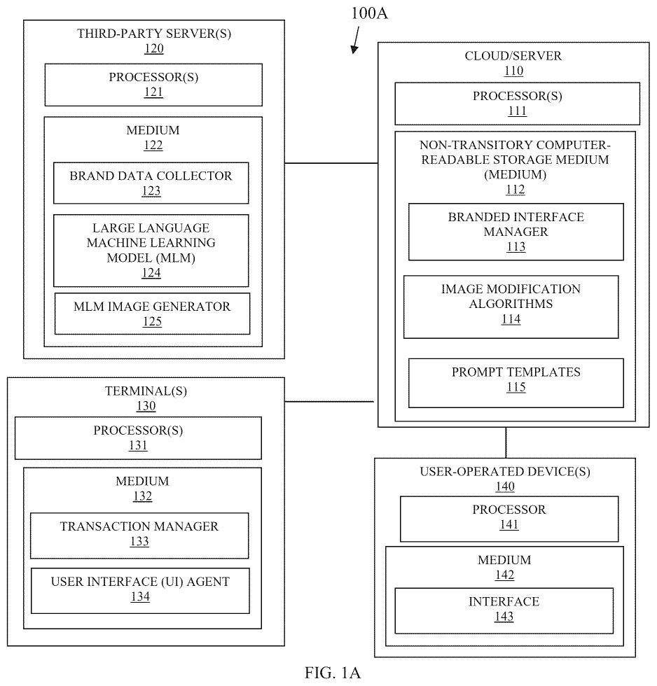

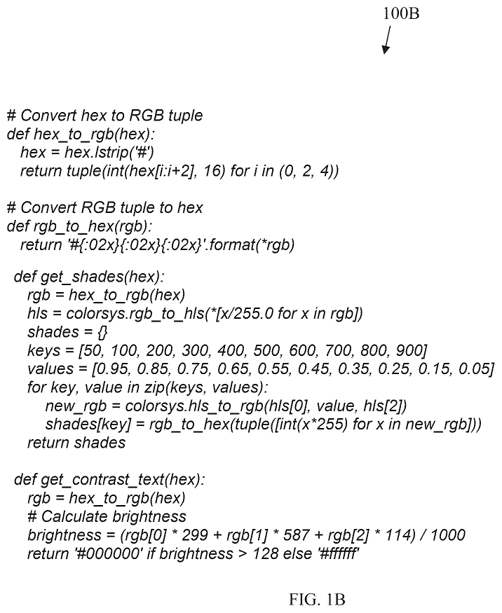

FIG. 1A is a diagram of a system 100A for terminal branding with automated machine learning MLM prompts, according to an example embodiment. Notably, the components are shown schematically in greatly simplified form, with only those components relevant to understanding of the embodiments being illustrated.

Furthermore, the various components (that are identified in system/platform 100A) are illustrated and the arrangement of the components are presented for purposes of illustration only. It is to be noted that other arrangements with more or less components are possible without departing from the teachings of providing personalized terminal branding with automated machine learning MLM prompts, presented herein and below.

System 100A includes a cloud 110 or server, one or more third-party servers 120, one or more terminals 130, and one or more user-operated devices 140. Cloud 110 includes at least one processor 111 and a non-transitory computer-readable storage medium 112 (medium), which includes instructions for a brand interface manager 113 and image modification algorithms 114. The instructions when executed by the processor 111 cause the processor 111 to perform operations discussed herein and below with respect to brand interface manager 113 and image modifications algorithms 114. Medium 112 also includes prompt templates 115 accessed from medium 112 by branded interface manager 113.

Each third-party server 120 includes at least one processor 121 and a medium 122, which includes instructions for a brand data collector 123, a large language MLM 124, and an MLM image generator 125. The instructions when executed by the processor 121 cause the processor 121 to perform the operations discussed herein and below with respect to brand data collector 123, large language MLM 124, and MLM image generator 125.

Each terminal 130 includes at least one processor 131 and a medium 132, which includes instructions for a transaction manager 133 and a UI agent 134. The instructions when executed by the processor 131 cause the processor 131 to perform the operations discussed herein and below with respect to transaction manager 133 and UI agent 134.

Each user-operated device 140 includes at least one processor 141 and a medium 142, which includes instructions for an interface 143. The instructions when executed by the processor 141 cause the processor 141 to perform operations discussed herein and below with respect to interface 143.

Branded interface manager 113 presents interface 143 on a user-operated device 140 to a user. The user initially enters into an input field of the interface a brand name for a brand. Responsive, to the brand name, branded interface manager 113 uses an application programming interface (API) to provide the brand name as input to a brand data collector. In an embodiment, the brand data collector is Brandfetch®.

The brand data collector 123 returns back a listing of websites or domains, logos, and descriptions for the brand name. Branded interface manager 113 presents the logos and the domains for selection within the interface 143 to the user. The user is also presented with color selections or color choices from which the user is requested to make 1-2 color selections. Further, the user is presented with theme options. The branded interface manager 113 receives back a user selected domain, one or more user selected logos, 1-2 color selections, and a theme selection. The interface 143 permits the user to pick the theme selection from a drop down menu listing holidays and events. In an embodiment, the drop down menu permits the user to select an “other theme” causing an input field to be presented within the interface 143 where the user enters any customized theme desired by the user; for example, the user can enter a “bicycle” theme. In an embodiment, interface 143 permits the user to upload logos preferred by the user as one or more of the user's selected logos.

Next, based on the user selected domain received through interface 143, branded interface manager 113 obtains the appropriate descriptions that were associated with the selected domain from the data provided by the branded data collector 123. Branded interface manager 113 provides the corresponding description of words as input to large language MLM 124 within a natural language sentence that requests that the large language MLM 124 return a predefined number of key or core words and/or core concepts from the provided description. In an embodiment, the predefined number is a single word. The large language MLM 124 specifically analyzes the descriptions to identify key concepts while excluding contradictory brand elements (e.g., excluding blue or Pepsi® for Coca-Cola® branding).

Branded interface manager 113 obtains a prompt template from a table or data store associated with prompt templates 115. In an embodiment, the template is selected from a plurality of available templates based on predefined criteria. The selected template is one or more natural language sentences which contains variable replacements for populating the sentence. Branded interface manager 113 substitutes variable replacements identified in the sentence of the template with the core word, the user-selected domain, and the user-selected theme. The prompt templates 115 are carefully curated to produce content related to the business of the brand.

For example, consider a selected prompt template appears as follows within the table or data store of prompt templates 115:

prompt_string = f″Create a simple and minimal
background with a {noun} located in the corner for {selected
domain} as {selected_holiday} theme in a hyper-realistic style.
Do not include any company logos other than
{selected_domain}. I want a simple, bare, plain, and empty
image.

The variable replacement string “{noun}” is replaced with the core word, the variable replacement string “{selected_domain}” is replaced with the user-selected domain, and the variable replacement string “{selected_holiday}” is replaced with the user selected theme. Also, notice that the last sentence in the selected prompt template specifically excludes other company logos which are not associated with the user-selected domain.

The branded interface manager 113 generates an automated MLM prompt by performing the replacements within the selected prompt template. Branded interface manager 113 provides the MLM prompt as input to MLM image generator 125, which returns a set of basic background images that conform to the conditions and criteria defined in the MLM prompt.

The branded interface manager 113 then processes the image modification algorithms 114 against the returned background images provided by the MLM image generator 125. First, a color processing algorithm is executed to conform colors reflected in the background images to the color(s) selected by the user. A color scheme is produced for each user selected color. FIG. 1B includes example pseudo code 100B for the foreground and background color calculation by the color processing algorithm.

In an embodiment, the user selects 2 colors. The first color is used as the background colors of buttons rendered within the background images during a transaction on a terminal 130. The text color on top of any button is computed as white if the button is perceived as dark, and black if the button is perceived as bright. The second user selected color is a main color for use with animations that are presented in transaction interface screens during a transaction on terminal 130. The color processing algorithm produces 10 shades of the second user selected color in the RGB space by converting to the HSL space, and then converting back to the RGB space resulting in 10 colors that can be used for transaction animations.

The color processing algorithm specifically ensures compliance with accessibility requirements through mathematical calculations. For buttons and text elements, the algorithm calculates contrast ratios between foreground and background colors to meet minimum accessibility standards. The perceived brightness calculations and color space conversions are specifically tailored to maintain readability while preserving brand aesthetics.

After the color processing algorithm provides the colors and gradations of color, a packaging algorithm of the image modification algorithms 114 is processed to package the colors and gradations into a standardized format within a color file. In an embodiment, the standardized format is a computer and human readable JSON file with color hex code.

Once the color file to apply to the background images, the buttons of the transaction interface, and the animations of the transaction interface are obtained, branded interface manager 113 applies a selected a style to apply to each of the background images. Research and experimentation on over thousands of styles are revealed a predefined set of styles that are worked optimally with user interface (UI) backgrounds. These styles include “hyper-realistic,” “Claude Monet,” “Jeff Koons,” “Francis Bacon,” “Pierre-Auguste Renoir,” and “Keith Haring.” In an embodiment, the branded interface manager 113 randomly selects one of the predefined styles to use for the background images. In an embodiment, the branded interface manager fixes the style to “hyper-realistic.” In an embodiment, the branded interface manager 113 selects a style from the predefined styles based on criteria or ratings associated with the predefined styles relative to the known color selections.

The packaging algorithm stores the background images, the user-selected logos, the color schemes contained in the color file, the selected style in storage on cloud 110. Branded interface manager 113 renders each background image with and without one or more of the logos using the style and color schemes and presents a variety of background images within the interface 143 for user selection.

Interface 143 also allows the user to assign a selected background image to a specific workflow state of a transaction interface for transaction manager 133. For example, the user selects 4 different versions of the background images, each version associated with a welcome state, an item scanning state, an item searching state, or a transaction conclusion and thank you state.

Responsive to these selections and assignments, branded interface manager 113 combines the corresponding background images, color schemes, logos, and transaction state into a standardized format. The branded interface manager 113 then converts the standard format into instructions and files which are consumable or recognized for processing by transaction manager 133. The instructions and files are sent to UI agent 134. UI agent 134 uses an API to communicate the instructions and filed to transaction manager 133 and transaction manager 133 implements the personalized branding within the transaction interface screens of the transaction interface during a checkout of a customer. Notably, any existing animations performed within the transaction interface also include the corresponding color schemes as was discussed above.

The system 100A implements a cloud-native, container-based architecture that enables efficient deployment across multiple products. This architecture allows the standardized format containing background images, color schemes, and logos to be easily consumed by different types of transaction terminals 130.

Application-specific conversion tools transform the standardized format into formats recognized by different terminal systems. For example, the system includes specific conversion capabilities for legacy SCO and modern SCO terminals 130. Each conversion tool processes the standardized format and generates terminal-specific instructions that maintain consistent branding across different platform implementations.

In an embodiment, the interface 143 also permits the user to recall previous selections and indicate that the user does not like the branding result being experienced on the terminals 130. Branded interface manager 113 presents the user with different options for selection and implements changes made by the user. Furthermore, branded interface manager can flag the original user selections such that the user is not shown those particular disliked selections during subsequent user sessions with branded interface manager 113. In this way a feedback loop and or rating mechanism permits branded interface manager 113 to learn from user sessions to provide better background image renderings for user selections in future user sessions.

The system 100A implements a learning mechanism that improves over time through analysis of user selections and uploaded images. When users upload their own logos or images, the MLM image generator 125 analyzes these assets to learn preferred styles and characteristics. This learning process enables the system 100A to generate more relevant and appealing background images in subsequent sessions based on accumulated style preferences and successful user selections.

In an embodiment, cloud 110 can include its own proprietary version of brand data collector 123, large language MLM 124, and/or MLM image generator 125. In this embodiment there may be no need for any third-party service integration into system 100A.

One now appreciates how system 100A reduces skill required for interface branding to nearly zero skill required. For example, the user simply picks a desired background image produced by system 100A after the user simply provides a brand name, a domain, one or more preferred logos, and 1 to 2 color selections. The user is permitted to view variations of background images some with logos and some without within a defined color scheme and select a desired background image. Further, the user can select more than 1 background image and assign each selected background image to a transaction interface state for transactions on terminals 130.

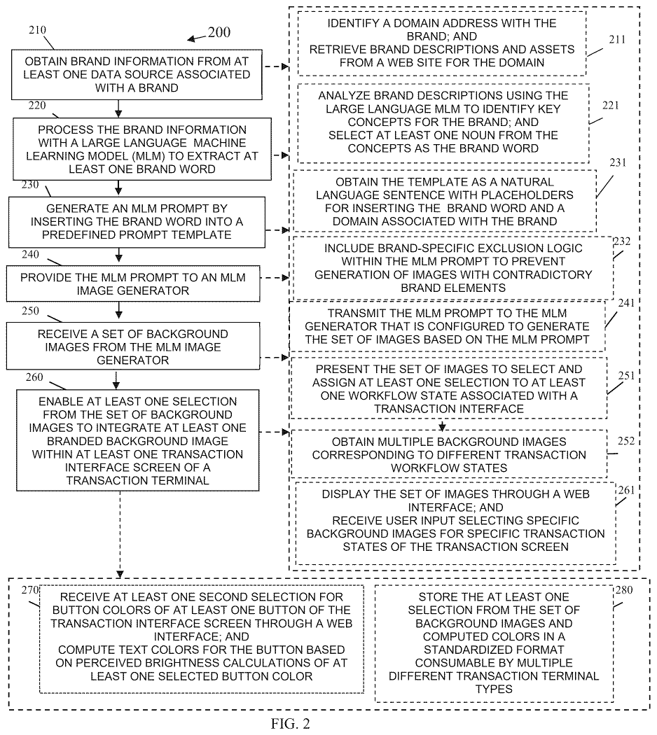

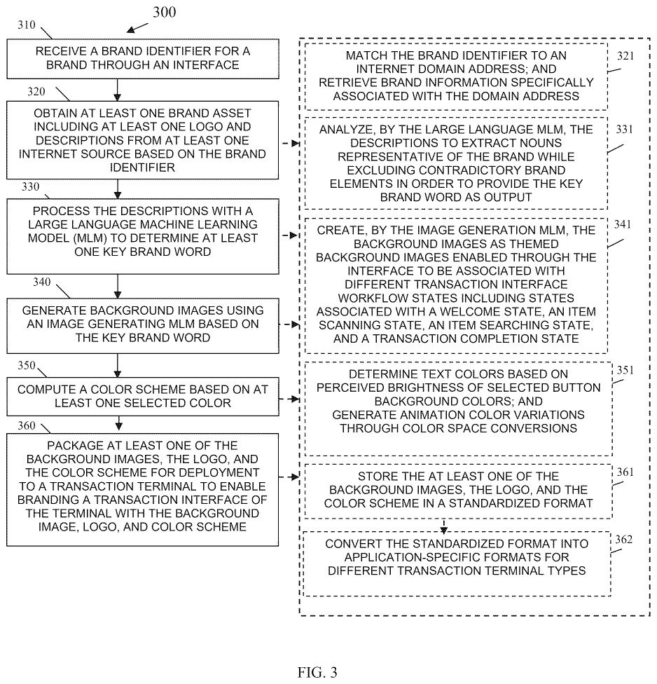

The above-referenced embodiments and other embodiments are now discussed within FIGS. 2-3. FIG. 2 is a flow diagram of a method 200 for personalizing terminal branding with automated machine learning MLM prompts, according to an example embodiment. The software module(s) that implements the method 200 is referred to as a “terminal branding manager.” The terminal branding manager is implemented as executable instructions programmed and residing within memory and/or a non-transitory computer-readable (processor-readable) storage medium and executed by one or more processors of one or more devices. The processor(s) of the device that executes the terminal branding manager are specifically configured and programmed to process the terminal branding manager. The terminal branding manager may have access to one or more network connections during its processing. The network connections can be wired, wireless, or a combination of wired and wireless.

In an embodiment, the device that executes the terminal branding manager is cloud 110. In an embodiment, the terminal branding manager is all or some combination of branded interface manager 113, image modification algorithms 114, brand data collector 123, large language MLM 124, and/or MLM image generator 125.

At 210, the terminal branding manager obtains brand information from at least one data source associated with a brand. In an embodiment, at 211, the terminal branding manager identifies a domain address with the brand and retrieves brand descriptions and assets from a web site for the domain. In an embodiment, the assets include logos, images of specific products or objects, etc.

At 220, the terminal branding manager process the brand information with a large language MLM 124 to extract at least one brand word. In an embodiment, at 221, the terminal branding manager analyzes brand descriptions using the large language MLM 124 to identify key concepts for the brand and selects at least one noun from the concepts as the brand word. In an embodiment, the large language MLM 124 returns the noun as output.

At 230, the terminal branding manager generates an MLM prompt by inserting the brand word into a predefined prompt template. In an embodiment, at 231, the terminal branding manager obtains the predefined prompt template as a natural language sentence with placeholders for inserting the brand word and a domain associated with the brand. In an embodiment, at 232, the terminal branding manager includes brand-specific exclusion logic within the MLM prompt to prevent generation of images with contradictory brand elements.

At 240, the terminal branding manager provides the MLM prompt to an MLM image generator 125. In an embodiment. At 241, the terminal branding manager transmits the MLM prompt to the MLM generator 125. The MLM image generator configured to generate a set of background images based on the MLM prompt.

At 250, the terminal branding manager receives a set of background images from the MLM image generator 125. In an embodiment, at 251, the terminal branding manager presents the set of images to select and assign to at least one selection to at least one workflow state associated with a transaction interface.

At 260, the terminal branding manager enables at least one selection from the set of background images to integrate at least one branded background image within at least one transaction interface screen of a transaction terminal 130. In an embodiment, at 261, the terminal branding manager displays the set of images through a web interface 143 and receives user input selection specific to the background images for specific transaction states of the transaction screen(s).

In an embodiment, at 270, the terminal branding manager receives at least one second selection for button colors of at least one button of the transaction interface screen through a web interface 143. The terminal branding manager computes text colors for the button based on perceived brightness calculations of at least one selected button color.

In an embodiment, at 280, the terminal branding manager stores at least one selection from the set of background images and computed colors in a standardized format. The standardized format is consumable or capable of being processed by multiple different transaction terminal types 130.

FIG. 3 is a diagram of another method 300 for personalizing terminal branding with automated machine learning MLM prompts, according to an example embodiment. The software module(s) that implements the method 300 is referred to as a “custom transaction interface brander.” The custom transaction interface brander is implemented as executable instructions programmed and residing within memory and/or a non-transitory computer-readable (processor-readable) storage medium and executed by one or more processors of a device. The processors that execute the custom transaction interface brander are specifically configured and programmed for processing the custom transaction interface brander. The custom transaction interface brander may have access to one or more network connections during its processing. The network connections can be wired, wireless, or a combination of wired and wireless.

In an embodiment, the device that executes the custom transaction interface brander is cloud 110. In an embodiment, custom transaction interface brander is all or some combination of branded interface manager 113, image modification algorithms 114, brand data collector 123, large language MLM 124, MLM image generator 125, and/or method 200. The custom transaction interface brander presents another and, in some ways, an enhanced processing perspective from that which was shown in method 200.

At 310, the custom transaction interface brander receives a brand identifier or brand name for a brand through an interface 143. At 320, the custom transaction interface brander obtains at least one brand asset including at least one logo and descriptions from at least one internet source based on the brand identifier. In an embodiment, at 321, the custom transaction interface brander matches the brand identifier to an internet domain address and retrieves brand information specifically associated with the domain address.

At 330, the custom transaction interface brander processes the descriptions with a large language MLM 124 to determine at least one key brand word for the brand. In an embodiment, at 331, the large language MLM 124, analyzes the descriptions to extract nouns representative of the brand while excluding contradictory brand elements in order to provide the key brand word as output.

At 340, the custom transaction interface brander generates background images using an image generating MLM 125 based on the key brand word. In an embodiment, at 341, the image generating MLM 125, creates the background images as themed background images enabled through the interface 143 to be associated with different transaction interface workflow states, which include a welcome state or start state, an item scanning state, an item searching state, and a transaction completion state or an end state.

At 350, the custom transaction interface brander computes a color scheme based on at least one selected color. In an embodiment, at 351, the custom transaction interface brander determines text colors based on perceived brightness of selected button background colors and the custom transaction interface brander generates animation color variations or gradations through color space conversions. In an embodiment of 351 and at 352, the custom transaction interface brander obtains multiple background images corresponding to different transaction workflow states.

At 360, the custom transaction interface brander packages at least one of the background images, the logo, and the color scheme for deployment to a transaction terminal 130 to enable branding a transaction interface of the transaction terminal 130 with the background image, the logo, and the color scheme. In an embodiment, at 361, the custom transaction interface brander stores the at least one background image, the logo, and the color scheme in a standardized format. In an embodiment of 361 and at 362, the custom transaction interface brander converts the standardized format into application-specific formats for different transaction terminal types.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining brand information from at least one data source associated with a brand;
processing the brand information with a large language machine learning model (MLM) to extract at least one brand word;
generating an MLM prompt by inserting the at least one brand word into a predefined prompt template;
providing the MLM prompt to an MLM image generator;
receiving a set of background images from the MLM image generator; and
enabling at least one selection from the set of background images to integrate at least one branded background image within at least one transaction interface screen of a transaction terminal.

2. The method of claim 1, wherein obtaining comprises:
identifying a domain address associated with the brand; and
retrieving brand descriptions and assets from a web site associated with the domain address.

3. The method of claim 1, wherein processing comprises:
analyzing brand descriptions using the large language MLM to identify key concepts associated with the brand; and
selecting at least one noun from the key concepts as the at least one brand word.

4. The method of claim 1, wherein generating comprises obtaining the predefined prompt template as a natural language sentence with placeholders for inserting the at least one brand word and a domain associated with the brand.

5. The method of claim 1, wherein generating comprises including brand-specific exclusion logic within the MLM prompt to prevent generation of images with contradictory brand elements.

6. The method of claim 1, wherein providing comprises transmitting the MLM prompt to the MLM image generator that is configured to generate the set of background images based on MLM prompt, wherein the MLM prompt is a natural language sentence.

7. The method of claim 1, wherein receiving comprises presenting the set of background images to select and assign the at least one selection to at least one workflow state associated with the at least one transaction interface screen.

8. The method of claim 7, wherein receiving comprises obtaining multiple background images corresponding to different transaction workflow states.

9. The method of claim 1, wherein enabling comprises:
displaying the set of background images through a web interface; and
receiving user input selecting specific background images for specific transaction states of the at least one transaction interface screen.

10. The method of claim 1, further comprising:
receiving at least one second selection of button colors for at least one button of the at least one transaction interface screen through a web interface; and
computing text colors for the at least one button based on perceived brightness calculations of at least one selected button color.

11. The method of claim 1, further comprising:
storing the at least one selection from the set of background images and computed colors in a standardized format consumable by multiple different transaction terminal types.

12. A method, comprising:
receiving a brand identifier for a brand through an interface;
obtaining at least one brand asset including at least one logo and descriptions from at least one internet sources based on the brand identifier;
processing the descriptions with a large language machine learning model (MLM) to determine at least one key brand word;
generating background images using an image generation MLM based on the at least one key brand word;
computing a color scheme based on at least one selected color; and
packaging at least one of the background images, the at least one logo and the color scheme for deployment to a transaction terminal to enable branding a transaction interface of the transaction terminal with at least one of the background images, the at least one logo, and the color scheme.

13. The method of claim 12, wherein obtaining comprises:
matching the brand identifier to an internet domain address; and
retrieving brand information specifically associated with the internet domain address.

14. The method of claim 12, wherein processing comprises analyzing, by the large language MLM, the descriptions to extract nouns representative of the brand while excluding contradictory brand elements in order to provide the at least one key brand word as output.

15. The method of claim 12, wherein generating further includes creating, by the image generation MLM, the background images as themed background images enabled through the interface to be associated with different transaction interface workflow states including states associated with a welcome state, an item scanning state, an item searching state, and a transaction completion state.

16. The method of claim 12, wherein computing comprises:
determining text colors based on perceived brightness of selected button background colors; and
generating animation color variations through color space conversions.

17. The method of claim 12, wherein packaging comprises storing the at least one of the background images, the at least one logo, and the color scheme in a standardized format.

18. The method of claim 17, further comprising:
converting the standardized format into application-specific formats for different transaction terminal types.

19. A system, comprising:
a web interface configured to receive brand information and color selections;
a machine learning model (MLM) configured to extract key brand concepts or words from the brand information;
an image generation MLM configured to generate themed background images based on the key brand concepts or words;
a color processing algorithm configured to compute text colors and animation color variations based on the color selections; and
a packaging algorithm configured to combine the themed background images and computed colors into a deployable format for transaction terminals to enable personalized branding of transaction interfaces of the transaction terminals.

20. The system of claim 19, further comprising:
a cloud storage configured to store the deployable format; and
a conversion algorithm configured to transform the deployable format into terminal-specific formats for different transaction terminal types.
